(19) United States
(12) Patent Application Publication
(10) Pub. No.: US 2012/0263469 A1
(43) Pub. Date: Oct. 18, 2012

(54) Method for Reducing Power Consumption of a Passive Optical Network

(75) Inventors: Jingjing Zhang, East Brunswick, NJ (US); Ting Wang, West Windsor, NJ (US); Naoto Saeki, Tokyo (JP)

(73) Assignees: NEC CORPORATION, Tokyo (JP); NEC LABORATORIES AMERICA, INC., Princeton, NJ (US)

(21) Appl. No.: 13/445,965

(22) Filed: Apr. 13, 2012

Related U.S. Application Data
(60) Provisional application No. 61/475,055, filed on Apr. 13, 2011.

(51) Int. Cl. H04J 14/00

(52) U.S. Cl. 398/66

(57) ABSTRACT

A method for reducing energy consumption of a passive optical network includes optical network units of the network which infer their downstream queue status rather than being explicitly notified by an optical line terminal of the network. Based on the inferred queue status, the optical network units make their own sleep mode decisions without assistance from optical line terminal. Both downstream traffic inference and sleep decision making at the optical network units are based on common information possessed by optical line terminal and optical network units. Accordingly, the optical line terminal can accurately infer the status of each optical network unit if the sleep control scheme implemented at an optical network unit is known by the optical line terminal.

### RELATED INVENTION

This application claims the benefit of U.S. Provisional Application No. 61/475,055, filed Apr. 13, 2011, the entire disclosure of which is incorporated herein by reference.

### FIELD

The present disclosure relates optical networking. More particularly, the present disclosure relates to methods for reducing power consumption of a passive optical network using traffic monitoring and inference techniques.

### BACKGROUND

An access network is a network that connects directly to an end user. Such networks are connected to a backbone network that interconnects the access network and various other networks in different buildings on a campus or cities in a country.

A passive optical network (TON) is a type of fiber-optic access network that generally includes a central office node or optical line terminal (OLT) at the central office of a service provider and one or more user nodes or optical network units (ONUs) near the end users. An optical distribution network (ODN) including, for example, optical fibers and splitters, connect the OLT and ONUs. PONs are reported to consume the smallest energy per transmission bit among various access technologies including WiMAX, FTTN, and point to point optical access networks.

Video-centric applications and services such as HDTV and social networking are growing and emerging in access networks. Because these applications are bandwidth-hungry, the bandwidth provisioned by currently deployed Ethernet based PONs (EPONs) will be filled up soon. In order to meet the high bandwidth requirements caused by these applications, the IEEE 802.3av 10G-EPON task force was charged to increase the provisioning data rate of EPONs to 10 Gb/s from 1 Gb/s, which is data rate provisioned in both downstream and upstream traffic by currently deployed 1G EPONs.

While the line rate is significantly increased to satisfy subscribers' demands, the power consumption of 10G-EPONs may be increased as well. The power consumption of 10G-EPONs has become a major concern for network service providers because it contributes to part of the operational expenditure of service providers. Moreover, energy consumption is becoming an environmental and therefore a social and economic issue because it is tied to climate change, which is believed to be due to the burning of fossil fuels and the direct impact of greenhouse gases on the earth's environment.

The power consumption of ONUs increase with the increase of line rate for a number of reasons. For example, with the increase of the line rate, optical dispersion increases as well. Compensating a higher dispersion exerts higher requirements on the optical lasers of an EPON, which may increase the power consumption of the lasers. In addition, electronic circuits of an EPON should be sufficiently powered such that they can process 10 times faster than that of a 1G-EPON. Thus, a 10G-EPON will consume more energy than a 1G-EPON.

Reducing power consumption of a 10G-EPON requires efforts across both the physical layer and the media access control (MAC) sub-layer (of the data link layer), of the network. Efforts are being made to develop optical transceivers and electronic circuits with low power consumption. In addition, multi-power mode devices with the ability of disabling certain functions can also help reduce the energy consumption of the network. However, low-power mode devices with some functions disabled may result in the degradation of network performance. To avoid the service degradation, it is important to properly design the MAC sub-layer control and scheduling schemes, which are aware of the disabled functions.

The prior art has proposed introducing a “sleep” mode into ONUS to save energy when ONUs are idle. ITU-T Recommendation G. sup 45 specifies two energy saving modes for ONUs in GPON. One of these modes is the “doze” mode, in which only the transmitter c′ be turned off when possible. The other mode is the “cyclic sleep” mode, in which both the transmitter and the receiver can be turned off. Since the access network traffic is rather bursty, ONUs may be idle for significantly long periods of time, implying that putting idle ONUs into the sleep mode is an effective way to reduce the energy consumption. However, it is challenging to timely wake up ONUs in the sleep mode, to avoid service disruption when downstream or upstream traffic arrives in 1G-EPONs and 10G-EPONs.

The major challenge lies in the downstream transmission. In an EPON, the downstream data traffic of all the ONUs are time division multiplexed (TDM) into a single wavelength, and then broadcasted to all the ONUs. An ONU receives all downstream packets, and checks whether the packets are destined to itself. An ONU does not know when the downstream traffic arrives at the OLT, and the exact time that the OLT schedules its downstream traffic. Therefore, without proper sleep-aware MAC control, receivers at ONUs need to be awake all the time to avoid missing its downstream packets.

The prior art has attempted to address this problem by implementing a three-way handshake process between the OLT and the ONUs before placing the ONUs into the sleep mode. Since the OLT is aware of the sleep status of each ONU, it can queue the downstream arrival traffic until the ONU wakes up. However, to implement the three-way handshaking process, an extended multipoint control protocol (MPCP) is required to introduce new MPCP protocol data its (PDUs). In addition the negotiation process also takes at least several round trip times, which further incurs large delay. The prior art has also attempted to implement fixed bandwidth allocation (FBA) when the network is lightly loaded. By using FBA, the time slots allocated to each ONU in each cycle is fixed and known to the ONU, and thus, the ONUs can switch into to the sleep mode in the time slots being allocated to other ONUs. However, since traffic of an ONU changes very frequently cycle from cycle, FBA may result in under or over bandwidth allocation, and consequently degrades service of the ONUs to some degree.

In addition to the downstream scenario, an efficient sleep control mechanism should also consider the upstream traffic and MPCP control message transmission. For the upstream transmission, the awakening of an ONU in the sleep mode can be triggered by the arrival of upstream traffic. However, this arrival traffic cannot be transmitted until the ONU is notified with the allocated time from the OLT. Before the OLT allocates bandwidth to an ONU, the newly awakened ONU needs to request tier upstream bandwidth. To realize this, some periodic time slots may need to be allocated to the ONUs to enable them access the upstream channel in time even when the ONUs are in the sleep mode.

Regarding the MPCP control message transmission, to keep a watchdog timer in the OLT from expiring and deregistering the ONU, both IEEE 802.3ah and IEEE 802.3av specify that the ONUs should periodically send MPCP REPORT messages to the OLT, to signal bandwidth needs as well as to arm the OLT watchdog timer even when no request for bandwidth is being made. The longest interval between two reports, as specified by “report_timeout” is set as 50 ms in both 1G-EPON and 10G-EPON. Further, the OLT also periodically sends GATE messages to an ONU even when the ONU does not have data traffic. The longest interval between two GATE messages, as specified in “gate_timeout,” is set as 50 ms. Therefore, to comply with the MPCP, ONUS in the sleep mode must wakeup every 50 ms to send the MPCP REPORT messages as well as to receive the GATE messages.

Accordingly, an improved sleep-aware traffic scheduling scheme is needed, which can be easily implemented to reduce energy consumption of EPONs.

### SUMMARY

Disclosed herein is a method for reducing energy consumption of a passive optical network comprising an optical line terminal and an optical network unit. The method comprises the steps of: at the optical network unit, determining in a computer process whether a packet destined from the optical network unit has arrived at a first time expected for the arrival of packets; and at the optical network unit, switching from an operational mode to a sleep mode if no packet has arrived at the first time.

Further disclosed herein is a method for reducing energy consumption of an optical network unit of a passive optical network. The method comprises the steps of: at the optical network unit, determining in a computer process whether a packet destined from the optical network unit has arrived at a first time expected for the arrival of packets; and at the optical network unit, switching from an operational mode to a sleep mode if no packet has arrived at the first time.

Also disclosed herein is a method for reducing energy consumption of a passive optical network comprising the steps of receiving at an optical line terminal a packet destined for the optical network unit; and holding the packet destined for an optical network unit at the optical line terminal if no packet had been scheduled to arrive at the optical network unit at a first time.

### BRIEF DESCRIPTION OF THE DRAWINGS

FIG. 1 is a diagram illustrating an exemplary embodiment of downstream traffic transmission in a PON in which an ONU downstream traffic inference process of the present disclosure may be applied.

FIG. 2 is a diagram illustrating the operation of a method, according to an exemplary embodiment of the present disclosure, for determining the duration of the sleep mode of an ONU.

FIG. 3 is a diagram illustrating a method, according to an exemplary embodiment of the present disclosure, performed at an OLT for avoiding downstream packet loss.

FIG. 4 is graph plotting energy savings resulting from the method of the present disclosure versus load.

FIG. 5 is a graph plotting delay resulting from the method of the present disclosure versus load.

FIG. 6 is a high-level flowchart depicting steps of the method of the present disclosure.

### DETAILED DESCRIPTION

The present disclosure describes a method for reducing energy consumption of a PON, such as an EPON comprising an OLT and one or more ONUs. The OLT and ONUs may each include one or more processors and one or more memory units for storing programs which are executable by the processors for implementing and performing the methods described herein. The method addresses the downstream traffic challenge without extending standardized MAC control protocol or degrading user services.

According to an aspect of the method, an ONU of the PON may infer the status of its downstream traffic (e.g., one or more packets destined for the ON which is queued at the OLT of the EPON, as shown in box 10 of the flowchart of FIG. 6. The inferring process of the present method may be based on the following rules: the OLT allocates time slots to the ONUs with non-empty downstream queues in a round-robin fashion; each ONU checks the headers of all the downstream packets and determines which packets are destined to itself; and the traffic arrival in access networks is rather bursty and exhibits strong self similarity. Using these rules, an ONU can make the following estimations: if an ONU has not received downstream traffic destined for itself for some time, the ONU must not have downstream traffic at this moment, and if downstream traffic destined to an ONU has not arrived for some time, it is highly likely that its downstream traffic will not arrive for some further time owing to the bursty nature of the downstream traffic.

Based on the above rules and estimations and so all of the ONUs are treated equally, the method assumes that the OLT allocates some time slots to all ONUs with non-empty downstream queues during each EPON dynamic bandwidth allocation (DBA) cycle. The method also assumes that ONUs are scheduled in order, e.g., 1, 2, . . . , N. If an ONU does not receive any packets destined for itself at a time that such downstream packets should arrive within one (1) ETON DBA cycle), the ONU can infer that its downstream traffic queue at the OLT, is empty, i.e., that it does not have any downstream traffic packets.

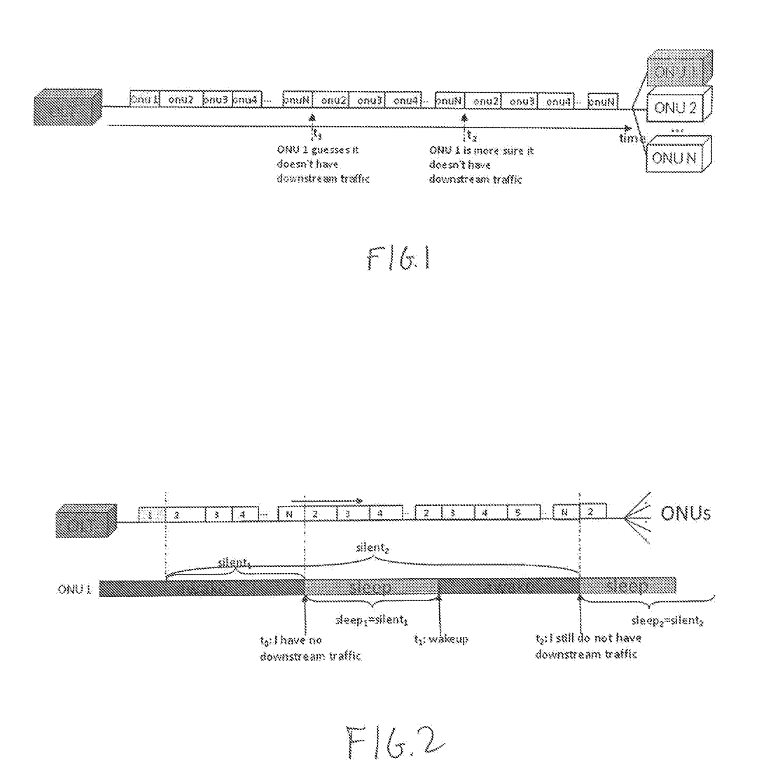

FIG. 1 illustrates an example of downstream traffic transmission in a EPON in which the ONU downstream traffic inference process may be applied. In the EPON, the OLT schedules the downstream traffic of ONUs in order, i.e., ONU 1, ONU 2, . . . , ONU N. So that all the ONUs are treated equally, the OLT allocates bandwidth to all ONUs with downstream traffic in each EPON DBA cycle. By default, an ONU checks all downstream packets and determines whether the packets are destined to it or not. At time t₁ (end of DBA cycle 1 after the transmission of the downstream traffic packet of ONU N), the OLT should have scheduled a downstream traffic packet destined for ONU 1, if the OLT has a downstream traffic packet queued for ONU 1. ONU 1, however, finds or determines that the OLT has scheduled a packet destined for ONU 2 rather than a packet destined for ONU 1. In accordance with the present method, ONU 1 may infer that it does not have a downstream traffic packet, otherwise the OLT would have scheduled and transmitted the traffic packet between the packets of ONU N and ONU 2. At time t₂ (end of DBA cycle 2 after the transmission of the downstream traffic packet of ONU N), the our again schedules a packet destined for ONU 2 rather than a packet destined for ONU 1, after ONU N. Consequently, ONU 1 has as a strong inference that its downstream traffic queue at OLT is empty.

The downstream queue status inference process of the present method does not require the OLT to explicitly notify the ONUs regarding their downstream traffic status using MAC layer control messages, as in prior art methods.

In accordance with a further aspect of the method, once the ONU has inferred the status of its downstream traffic queued at the OLT, it uses this inferred status to determine whether to switch from a full-power, operational mode to a low-power, energy-saving sleep mode, as shown in box 20 of the flowchart of FIG. 6. If the ONU inferabiy determines that its downstream traffic queue at the OLT is empty, the ONU will switch from the operational mode to the sleep mode after deciding the time duration of the sleep mode, i.e., how long the ONU should be in sleep mode, as shown in box 30 of the flowchart of FIG. 6. The time duration of the sleep mode may depend on many factors such as its historical traffic profile, the historical traffic profile of other ONUs, the time it takes for an ONU to wake up from the sleep mode (re-enter the full-power, operational mode), and the power the ONU spends to wake up from the sleep control protocol, as well as the MAC control protocol.

FIG. 2 illustrates the operation of a method, according to an exemplary embodiment of the present disclosure, for determining the duration of the sleep mode. Based on the similarity of the access network traffic, it is assumed that a downstream traffic packet will not arrive for another x time if the downstream traffic packet has not arrive for x time. Thus, if an ONU does not receive downstream traffic packets for x DBA cycles, it will switch into sleep status and sleep for y DBA cycles. Parameters x and y determine the energy saving performance of the EPON. The term “sleepᵢ” denotes the time duration of the ith sleep mode of an ONU, and “silentᵢ” denotes the time duration that an ONU has not receive any downstream packets. As illustrated in FIG. 2, at time tₒ (end of a DBA cycle), ONU 1 determines that it does not have downstream traffic, and then determines to sleep for time steep₁, which equals silent₁. At time t₁ (end of DBA cycle 1), ONU 1 wakes up from the sleep mode, and then determines whether it has a downstream packet or packets. At time t₂ (end of DBA cycle 2), after determining that it still does not have downstream traffic packets, ONU 1 again enters into the sleep mode where the sleep mode time duration sleep₂ equals silent₂.

Ideally, the ONU in the sleep mode is expected to wakeup (i.e., switch back to the full power, operational mode) when its downstream traffic arrives. It is difficult, however, for the ONU to know the exact arrival time of a future incoming traffic packet. The ONU may wake up before its next downstream packet (early wakeup) or the ONU may wake up after its next downstream packet arrives (late wakeup). Late wakeup may cause packet loss, and thus service degradation. Therefore, in accordance with another aspect of the method, as shown in box 40 of the flowchart of FIG. 6, the OLT uses the downstream traffic schedule to identify each corresponding ONU's downstream queue status inference and may be provided ith the same sleep duration process that is implemented at each of its corresponding ONUs to determine the sleep mode duration of each ONU. By doing so, the OLT can accurately infer the sleep status of the ONUs. After the downstream packet of an ONU arrives, the OLT may buffer this ONU's packet(s) and schedule it for delivery after the ONU wakes up, as shown in box 50 of the flowchart of FIG. 6.

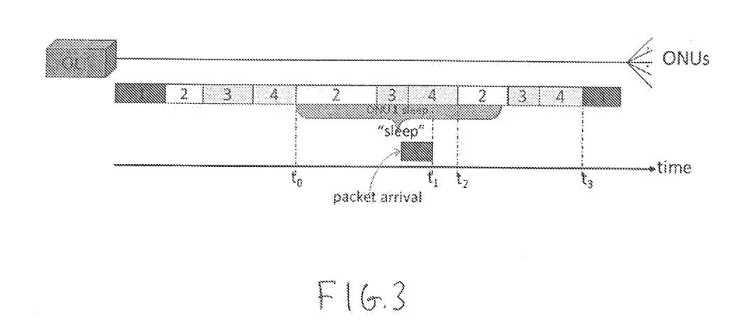

FIG. 3 illustrates the method performed at the OLT for avoiding downstream packet loss. In FIG. 3, the EPON includes an OTL and plural ONUS, e.g., ONU 1, ONU 2, ONU 3 and ONU 4. The scheduling order of the ONUs may be ONU 1, ONU 2, ONU 3, ONU 4. At time t₀, ONU 1 expects the packet destined to itself, but receives packets destined to ONU 2 instead. Therefore, ONU 1 decides to enter the sleep mode for time “sleep”. At time t₁ (end of DBA cycle 1), downstream packets destined for ONU 1 arrive at the OLT. At time t₂ (end of DBA cycle 2), although ONU 1 has downstream traffic now, it is still in the sleep mode. If the OLT is not aware of the sleep status of ONU 1, it schedules traffic of ONU 1. However, in accordance with the present method, the OLT is recognizes the sleep status of ONU 1 using the downstream traffic schedule and the sleep duration process implemented at ONU 1 and thereby can schedule the traffic destined to ONU 2 instead. At time t₃, the next DBA cycle begins (DBA cycle 3) and the ONU 1 is now awake in the full-power operational mode, and its packet can be scheduled for transmission to ONU 1.

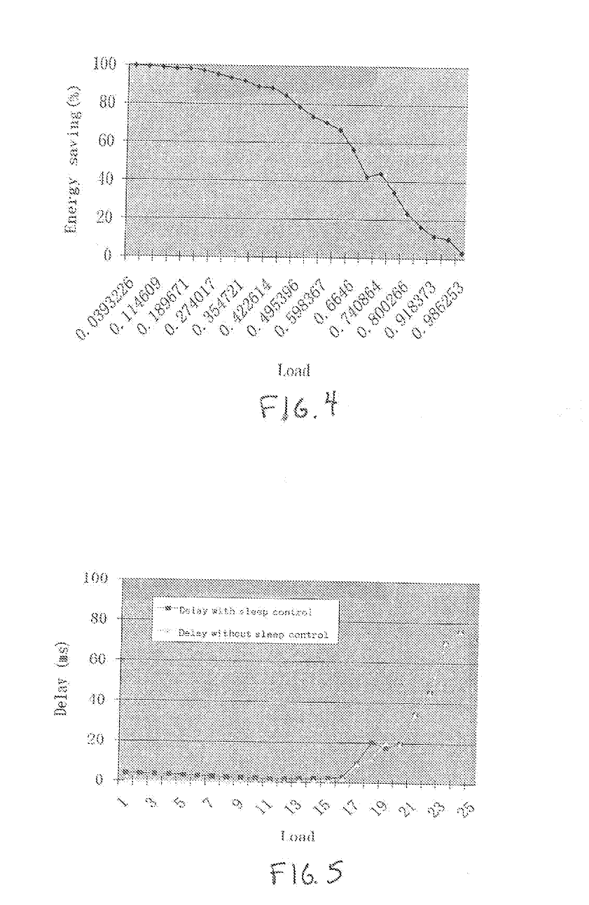

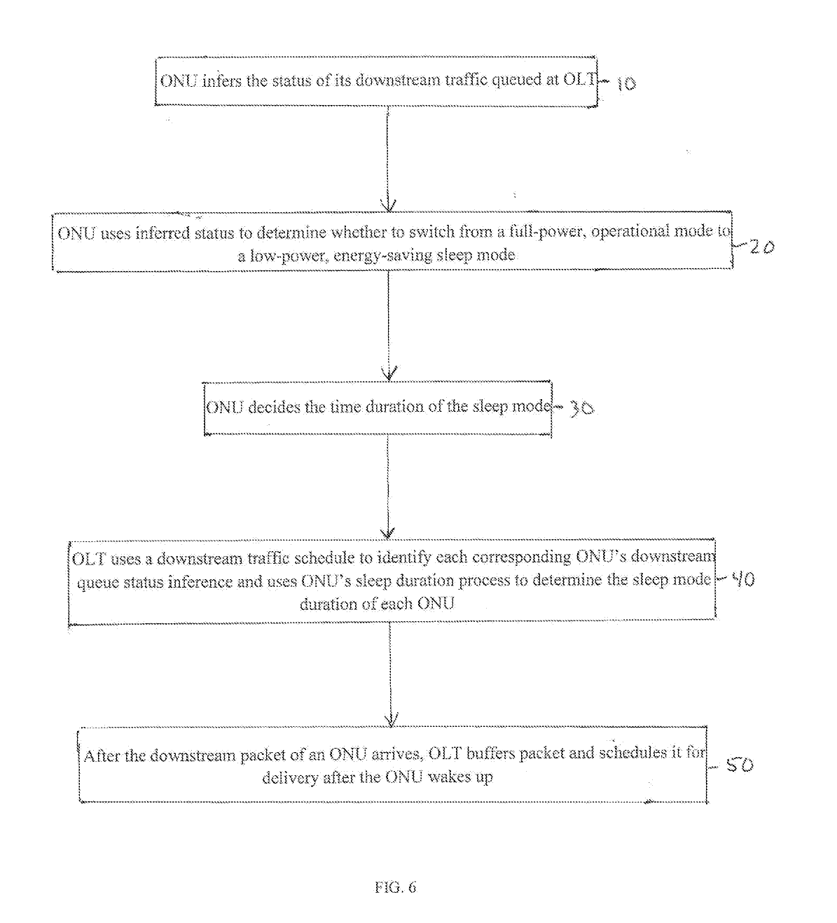

FIGS. 4 and 5 show the performances of the method. The simulation settings are as follows. The EPON had a 1 Gb/s downstream link rate and 32 ONUS. Each ONU was input with self-similar traffic which is the typical traffic pattern of HTTP, ftp, and VBR video applications. The traffic was uniform among all the ONUS. The traffic load was defined as the ratio between the overall incoming traffic and the network capacity. FIG. 4 shows that when the EPON was low loaded, the energy saving was as high as 90%. With an increase in network traffic load, the energy saving was reduced. When the network load was 60%, the energy saving was still as high as 70%. No significant energy saving was achieved when the load was increased beyond 90%.

Owing to the late wakeup, some extra delay n may be introduced. FIG. 5 compares the delay performances after introducing the sleep control scheme of the present method and that without sleep control. As can be seen in FIG. 5, when the EPON was lightly loaded, some extra delay was introduced by adding the sleep control scheme of the present method. When the EPON was highly loaded, the delay differences were negligible.

While exemplary drawings and specific embodiments of the present disclosure have been described and illustrated, it is to be understood that that the scope of the invention as set forth in the claims is not to be limited to the particular embodiments discussed. Thus, the embodiments shall be regarded as illustrative rather than restrictive, and it should be understood that variations may be made in those embodiments by persons skilled in the art without departing from the scope of the invention as set forth in the claims that follow and their structural and functional equivalents.

What is claimed is:

1. A method for reducing energy consumption of a passive optical network comprising an optical line terminal and an optical network unit, the method comprising the steps of:
at the optical network unit, determining in a computer process whether a packet destined from the optical network unit has arrived at a first time expected for the arrival of packets; and
at the optical network unit, switching from an operational mode to a sleep mode if no packet has arrived at the first time.

2. The method according to claim 1, further comprising the steps of:
receiving at the optical line terminal a packet destined for the optical network unit; and
holding the packet destined for the optical network unit at the optical line terminal if no packet had been scheduled to arrive at the optical network unit at the first time.

3. The method according to claim 1, wherein the switching step includes determining in a computer process the duration of the sleep mode based on a time period when no packet is received by the network optical unit.

4. The method according to claim 3, further comprising the steps of:
receiving at the optical line terminal a packet destined for the optical network unit; and
holding the packet destined for the optical network unit at the optical line terminal if no packet had been scheduled to arrive at the optical network unit at the first time.

5. The method according to claim 4, further comprising the step of:
at the optical line terminal, determining in a computer process the duration of the sleep mode based on a time period when no packet is received by the optical network unit.

6. The method according to claim 5, further comprising the step of:
at the optical line terminal, transmitting the held packet to the optical network unit based on the determined duration of the sleep mode of the optical network unit.

7. The method according to claim 6, wherein the transmitting step is performed when the optical network unit is in the operational mode.

8. The method according to claim 3, further comprising the step of:
at the optical network unit, staying in the operational mode if a packet has arrived at the first time.

9. The method according to claim 1, further comprising the step of:
at the optical network unit, staying in the operational mode if a packet has arrived at the first time.

10. A method for reducing energy consumption of an optical network unit of a passive optical network, the method comprising the steps of:
at the optical network unit, determining in a computer process whether a packet destined from the optical network unit has arrived at a first time expected for the arrival of packets; and
at the optical network unit, switching from an operational mode to a sleep mode if no packet has arrived at the first time.

11. The method according to claim 10, wherein the switching step includes determining in a computer process the duration of the sleep mode based on a time period when no packet is received by the optical network unit.

12. The method according to claim 10, further comprising the step of:
at the optical network unit, staying in the operational mode if a packet has arrived at the first time.

13. A method for reducing energy consumption of a passive optical network comprising an optical line terminal and an optical network unit, the method comprising the steps of:
receiving at the optical line terminal a packet destined for the optical network unit; and
holding the packet destined for the optical network unit at the optical line terminal if no packet had been scheduled to arrive at the optical network unit at a first time.

14. The method according to claim 13, further comprising the step of:
at the optical line terminal, determining in a computer process the duration of the sleep mode based on a time period when no packet is received by the optical network unit.

15. The method according to claim 14, further comprising the step of:
at the optical line terminal, transmitting the held packet to the optical network unit based on the determined duration of the sleep mode of the optical network unit.

16. The method according to claim 15, wherein the transmitting step is performed when the optical network unit is in the operational mode.
